(19) United States
(12) Patent Application Publication
(10) Pub. No.: US 2025/0004841 A1
(43) Pub. Date: Jan. 2, 2025

(54) TASK MANAGEMENT IN COMPILING PROCESS

(71) Applicant: INTERNATIONAL BUSINESS MACHINES CORPORATION, ARMONK, NY (US)

(72) Inventors: JIU FU GUO, Shanghai (CN); Gui HaoChen, Shanghai (CN); Chaofan Qiu, Shanghai (CN); Li Rong Yi, Shanghai (CN)

(21) Appl. No.: 18/346,217

(22) Filed: Jul. 1, 2023

(51) Int. Cl. G06F 9/50

(52) U.S. Cl. CPC G06F 9/5027

(57) ABSTRACT

A method, computer system, and a computer program product for task management is provided. The present invention may include generating a plurality of tasks. The present invention may include determining a plurality of task chains based on dependencies among the plurality of tasks. The present invention may include identifying a critical task chain with a maximum time-cost weight from the plurality of task chains. The present invention may include scheduling a critical task chain to be executed with a highest priority.

### BACKGROUND

The present invention relates generally to the field of computing, and more particularly to task management in a compiling process.

Compiling may generally refer to a process of converting source codes into object codes, and a tool used to realize this process may be referred to as a compiler. The compiler may only convert one compilation unit at a time, and the so-called compilation unit refers to a single source file. Programs may be composed of multiple source files, and therefore building systems may be adopted to generate object files that users can use from multiple source files. A building process which may be performed by the building systems may include compiling and linking.

### SUMMARY

Embodiments of the present invention disclose a method, computer system, and a computer program product for task management in a compiling process. The present invention may include generating a plurality of tasks. The present invention may include determining a plurality of task chains based on dependencies among the plurality of tasks. The present invention may include identifying a critical task chain with a maximum time-cost weight from the plurality of task chains. The present invention may include scheduling a critical task chain to be executed with a highest priority.

According to an embodiment of the present disclosure, there is provided a computer-implemented method for task management in a compiling process with a plurality of optimization passes. In the computer-implemented method, a plurality of tasks can be generated by one or more processing units. Each optimization pass in the plurality of optimization passes can operate on an operation unit smaller than a source file, and each task in the plurality of tasks can be represented by an optimization pass in the plurality of optimization passes and a corresponding operation unit of the optimization pass. A plurality of task chains can be determined by one or more processing units based on dependencies among the plurality of tasks. Each of the plurality of task chains can comprise one or more tasks of the plurality of tasks. A critical task chain with a maximum time-costing weight can be identified from the plurality of task chains by one or more processing units based on a time-costing weight of each task chain in the plurality of task chains. The critical task chain can be scheduled to be executed with the highest priority and other task chains can be scheduled to be executed in parallel with the critical task chain by one or more processing units.

According to another embodiment of the present disclosure, there is provided a system for task management in a compiling process with a plurality of optimization passes. The system can comprise one or more processors, a memory coupled to at least one of the processors and a set of computer program instructions stored in the memory. When executed by at least one of the processors, the set of computer program instructions can perform following actions. A plurality of tasks can be generated. Each optimization pass in the plurality of optimization passes can operate on an operation unit smaller than a source file, and each task in the plurality of tasks can be represented by an optimization pass in the plurality of optimization passes and a corresponding operation unit of the optimization pass. A plurality of task chains can be determined based on dependencies among the plurality of tasks. Each of the plurality of task chains can comprise one or more tasks of the plurality of tasks. A critical task chain with a maximum time-costing weight can be identified from the plurality of task chains based on a time-costing weight of each task chain in the plurality of task chains. The critical task chain can be scheduled to be executed with the highest priority and other task chains can be scheduled to be executed in parallel with the critical task chain.

According to another embodiment of the present disclosure, there is provided computer program product for task management in a compiling process with a plurality of optimization passes. The computer program product can comprise a computer readable storage medium having program instructions embodied therewith. The program instructions are executable by a processor to cause the processor to perform following actions. A plurality of tasks can be generated. Each optimization pass in the plurality of optimization passes can operate on an operation unit smaller than a source file, and each task in the plurality of tasks can be represented by an optimization pass in the plurality of optimization passes and a corresponding operation unit of the optimization pass. A plurality of task chains can be determined based on dependencies among the plurality of tasks. Each of the plurality of task chains can comprise one or more tasks of the plurality of tasks. A critical task chain with a maximum time-costing weight can be identified from the plurality of task chains based on a time-costing weight of each task chain in the plurality of task chains. The critical task chain can be scheduled to be executed with the highest priority and other task chains can be scheduled to be executed in parallel with the critical task chain.

In another embodiment, the method may include scheduling a first task in the other task chains that is depended by a second task in the critical task chain to be executed before execution of the second task.

In a further embodiment, the method may include merging one or more tasks in the plurality of tasks with time-costing weights less than a threshold into one task.

In yet another embodiment, the method may include reducing two same tasks into one task, wherein the two same tasks are generated based on two optimization passes which are related to two source files respectively.

In addition to a method, additional embodiments are directed to a computer system and a computer program product for task management in a compiling process.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts a block diagram of an exemplary computing environment according to at least one embodiment;

FIG. 2 is an operational flowchart illustrating a process for task management in a compiling process according to at least one embodiment;

FIG. 3 depicts an exemplary diagram of tasks and task chains according to at least one embodiment;

FIG. 4 depicts an exemplary diagram of tasks related to two source files and corresponding task chains according to at least one embodiment; and

FIG. 5 depicts an exemplary system for task management in a compiling process with a plurality of optimization passes according to at least one embodiment.

### DETAILED DESCRIPTION

The following described exemplary embodiments provide a system, method and program product for task management. As such, the present embodiment has the capacity to improve the technical field of task management by enabling task management in a compiling process utilizing a plurality of optimization passes. More specifically, the present invention may include generating a plurality of tasks. The present invention may include determining a plurality of task chains based on dependencies among the plurality of tasks. The present invention may include identifying a critical task chain with a maximum time-cost weight from the plurality of task chains. The present invention may include scheduling a critical task chain to be executed with a highest priority.

As described previously, compiling may generally refer to a process of converting source codes into object codes, and a tool used to realize this process is called a compiler. The compiler may only convert one compilation unit at a time, and the so-called compilation unit refers to a single source file. Programs may be composed of multiple source files, and therefore building systems may be adopted to generate object files that users can use from multiple source files. A building process which is performed by the building systems may include compiling and linking.

Therefore, it may be advantageous to, among other things, generate a plurality of tasks, determine a plurality of task chains based on dependencies among the plurality of tasks, identify a critical task chain with a maximum time-cost weight from the plurality of task chains, and schedule a critical task chain to be executed with a highest priority.

As discussed above, compiling can usually be performed in a unit of a source file. If a first source file is very large and it is depended by a second source file, it may take a very long time to compile the first source file, resulting in a delay in compiling the second source file. During a compiling process for a single source file, a plurality of optimization passes, which correspond to a plurality of optimization methods, can be executed. The optimization passes may take up most of the compiling time. However, the optimization passes may be executed sequentially, resulting in a relatively long time to compile a single source file and an insufficient use of compiling resource.

Embodiments of the present disclosure aim to solve at least one of the technical problems described above, and propose a method, a system and computer program product for task management in a compiling process with a plurality of optimization passes, which can make compiling be performed in units of tasks related to optimization passes and make the tasks be executed in parallel, maximizing use of compiling resources and reduce compiling time.

The inventors of the present disclosure have realized that, from the perspective of the compiler, the compiling process may actually happen in smaller units than a whole source file. Such units can be functions usually, or sometimes even smaller, like loops or basic blocks. The most time-consuming part during compiling is a series of optimization passes, which correspond to optimization methods. The optimization passes can operate on the smaller units, and most of them are actions of analyzing or transforming the smaller units.

Therefore, the inventors of the present disclosure have come up with an idea to make the compiling be performed in units of tasks related to optimization passes instead of the whole source file, and make the tasks be executed in parallel as much as possible, so that the use of compiling resources can be maximized and the compiling time can be reduced. The method, a system and computer program product for task management proposed in the present disclosure based on the idea can not only speed up compiling of a single source file, but also be incorporated into the existing building systems to speed up compiling of multiple source files.

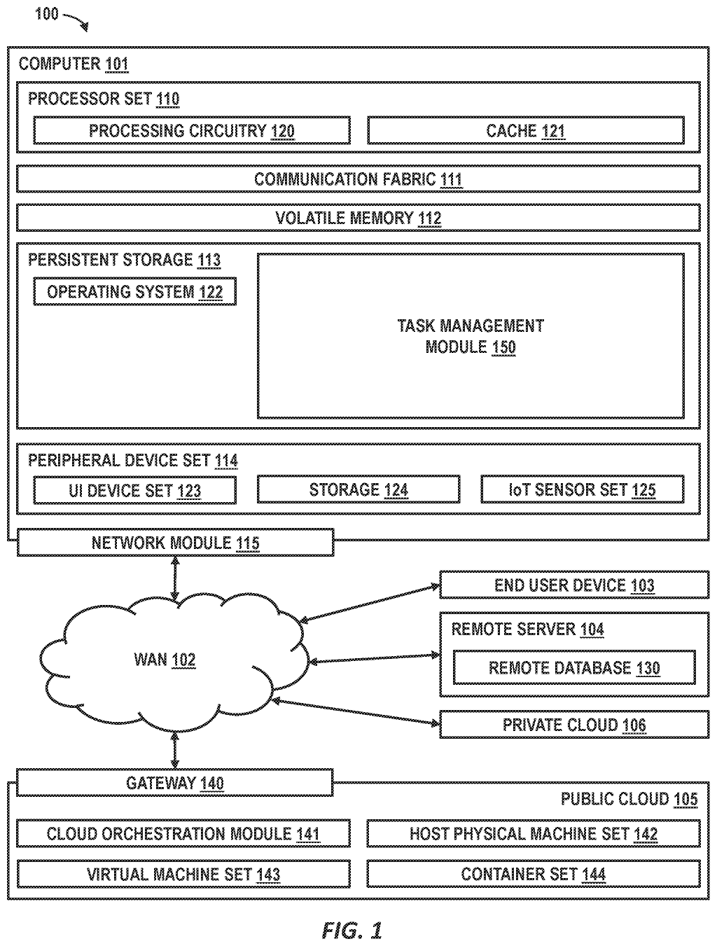

Referring to FIG. 1, Computing environment 100 contains an example of an environment for the execution of at least some of the computer code involved in performing the inventive methods, such as task management in a compiling process utilizing a plurality of optimization passes using task management module 150 (e.g., task management code 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

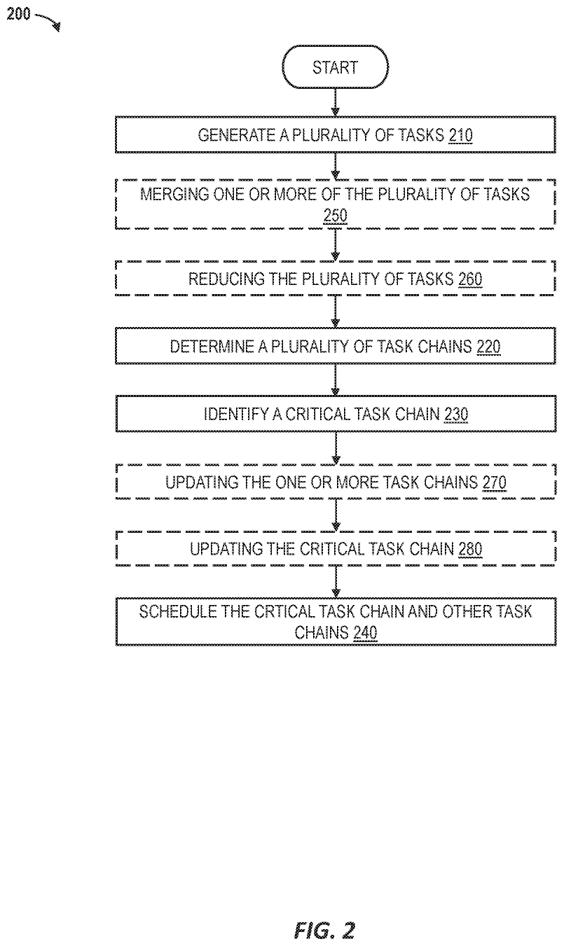

According to the present embodiment, the computer environment 100 may use the task management module 150 (e.g., task management code 150) for task management in a compiling process with a plurality of optimization passes. The task management method is explained in more detail below with respect to FIG. 2.

Referring now to FIG. 2, an operational flowchart illustrating the exemplary task management process 200 used by the task management module 150 (e.g., task management code 150) according to at least one embodiment is depicted.

At step 210, a plurality of tasks can be generated. As described above, a compiling process can include a plurality of optimization passes, and each optimization pass in the plurality of optimization passes can operate on an operation unit smaller than a source file. As described above, compiling can usually be performed in a unit of a source file. A source file usually includes at least one of a function, a loop or a basic block. During a compiling process for a single source file, a plurality of optimization passes can be executed. In some embodiments, the operation unit can be a function, a loop or a basic block. A function can include one or more loops and/or one or more basic blocks, and a loop can include one or more basic blocks. Generation of the plurality of tasks at step 210 can be viewed as a process of combining optimization passes with corresponding operation units. Therefore, each task in the generated plurality of tasks can be represented by an optimization pass in the plurality of optimization passes of the compiling process and a corresponding operation unit of the optimization pass. As an example, the task can be represented by a tuple such as in a form of Task (Pass, Unit). For instance, a task regarding a function optimization pass which operates on a Function A can be represented by Task (FunctionPass A, Function A). Similarly, a task regarding a loop optimization pass which operates on a Loop B can be represented by Task (LoopPass B, Loop B). Compiler front-end can be treated as a special optimization pass which operates on an operation unit of one source file, and a corresponding special task can be generated. The compiler front-end mentioned herein refers to a process of analyzing and understanding program codes in a source file, which usually includes lexical analysis, grammatical analysis and semantic analysis of program codes. The special task can be scheduled to be executed first and before any other tasks.

As will be explained in more detail below, step 210 may optionally include step 250 after step 210. Step 250 may be shown in FIG. 2, method 200, using dashed lines which may represent the optionality of merging one or more tasks of the plurality of tasks with time-costing weights less than a threshold may be merged into one task.

Additionally, as will be explained in more detail below, step 210 may optionally include step 260 after step 210. Step 260 may be show in FIG. 2, method 200, using dashed lined which may represent the optionality of reducing two same tasks and/or similar tasks generated based on two optimization passes which may be related to two source files respectively.

At step 220, a plurality of task chains can be determined based on dependencies among the plurality of tasks. If a task M cannot be executed until an execution of a task N may be completed, then task M depends on task N. Based on dependencies among the plurality of tasks, execution sequences of the tasks can be determined and therefore a plurality of task chains can be determined. Each of the plurality of task chains can include one or more tasks of the plurality of tasks.

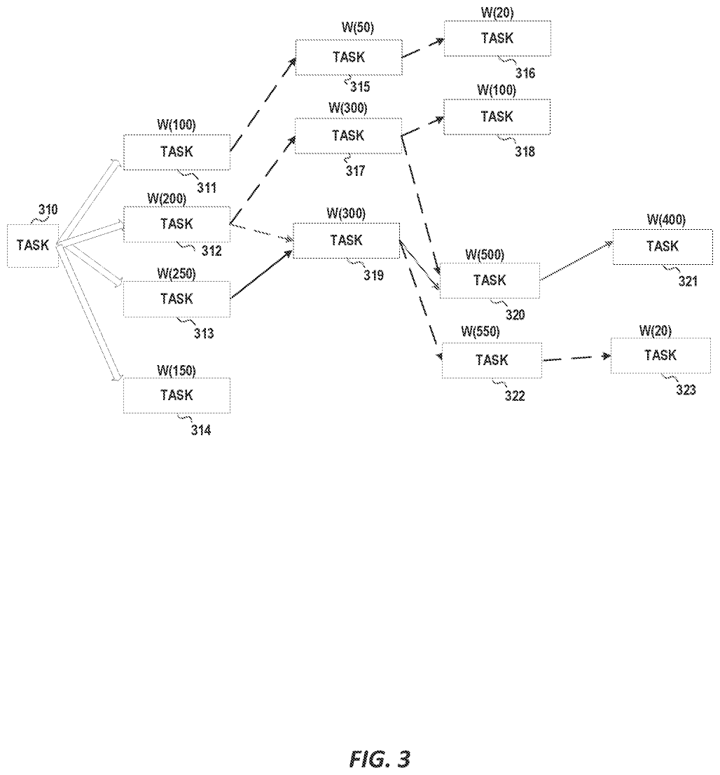

With reference now to FIG. 3, it may be shown an exemplary diagram of tasks and task chains. As shown in FIG. 3, a plurality of tasks labeled as tasks 310-323 can be generated. Among the tasks, task 310 may be the special task generated for the compiler front-end and may be the start of any task chains. Although task 310 may be shown as the start of any task chains in FIG. 3, it can also be considered outside each task chain. Based on dependencies among the plurality of tasks, and a plurality of task chains can be determined. The arrows in FIG. 3 represent corresponding dependencies among tasks. In the example of FIG. 3, there may be shown eight task chains determined based on the dependencies, namely, a first task chain (311)-(315)-(316), a second task chain (312)-(317)-(318), a third task chain (312)-(317)-(320)-(321), a fourth task chain (312)-(319)-(320)-(321), a fifth task chain (312)-(319)-(322)-(323), a sixth task chain (313)-(319)-(320)-(321), a seventh task chain (313)-(319)-(322)-(323), and an eighth task chain (314).

In some embodiments, the dependencies among the plurality of tasks can be based on dependencies among corresponding operation units. As an example, an execution of an optimization pass for a function has to be completed before executions of optimization passes for loops or basic blocks inside the function, that is, loops and basic blocks inside the function depend on the function. Therefore, if Loop B may be inside Function A and thus depending on Function A, Task (LoopPass B, Loop B) can be determined to depend on Task (FunctionPass A, Function A).

In some embodiments, the dependencies among the plurality of tasks can be based on dependencies among corresponding optimization passes. As an example, an execution of an optimization pass for Function C cannot be started before executions of optimization passes for Function A and Function B are completed, if Function C may be related to both Function A and Function B. For instance, Function C can be an inline function to embed Function A into Function B. As a result, optimization passes for the Function C depend on the optimization passes for Function A and Function B. Therefore, Task (FunctionPass C, Function C) depends on Task (FunctionPass A, Function A) and Task (FunctionPass B, Function B).

There may be various tasks related to various optimization passes and corresponding operation units, therefore, in some embodiments, the dependencies among the plurality of tasks can be based on both of the dependencies among corresponding optimization passes and the dependencies among corresponding operation units.

Referring back to FIG. 2, at step 230, a critical task chain with a maximum time-costing weight can be identified from the plurality of task chains based on a time-costing weight of each task chain in the plurality of task chains. Each task chain can have a corresponding time-costing weight. A task chain with the maximum time-costing weight can be identified by comparing time-costing weights of the plurality of task chains. The task chain with the maximum time-costing weight may be defined as the critical task chain herein.

The time-costing weight of a task chain can be a numerical statistic of time-costing weights of the one or more tasks in the task chain, and a time-costing weight of a task indicates time consumed by a corresponding optimization pass to operate on a corresponding operation unit. In some embodiments, time-costing weight of a task chain can be a sum of time-costing weights of the one or more tasks in the task chain. In some embodiments, time-costing weight of a task chain can be an average of time-costing weights of the one or more tasks in the task chain.

Referring back to FIG. 3, the time-costing weight of each task may be represented as W. For example, the time-costing weight of task 311 may be 100, the time-costing weight of task 317 may be 300, etc. With time-costing weights of tasks in a task chain, the time-costing weight of that task chain can be calculated. For example, the time-costing weight of the task chain can be calculated as a sum of time-costing weights of the tasks in the task chain. Therefore, with respect to the first task chain (311)-(315)-(316), the time-costing weight thereof can be calculated as a sum of time-costing weights of the 3 tasks of 311, 315 and 316 in the first task chain, which may be 100+50+20=170. Similarly, the time-costing weights of the other seven task chains can be calculated. The sixth task chain (313)-(319)-(320)-(321) with the maximum time-costing weight (which may be 250+300+500+400=1450) may be identified as the critical task chain among the eight task chains. The arrows in the critical task chain are shown as solid lines, while the arrows in other task chains are shown as dash lines.

In some embodiments, the time-costing weight of a single task can be calculated based on a time complexity of the corresponding optimization pass and a size of the corresponding operation unit. As described above, a task may be represented by an optimization pass and a corresponding operation unit. Different optimization passes can have different time complexities, which affect the time consumed by tasks and affect the time-costing weights accordingly. For example, an optimization pass related to a function optimization takes a different time from an optimization pass related to a loop optimization or a basic-block optimization. The size of the operation unit also affects the time consumed by the task. The size of the operation unit mentioned herein can be a size of a function body if the operation unit of a task may be a function, a depth of a loop if the operation unit of a task may be a loop, or the number of symbols if the operation unit of a task may be a function or a basic block, etc. For example, a function with a larger size of function body causes the corresponding optimization pass to take more time than a function with a smaller size of function body. For another example, the deeper a loop may be, the larger its size may be, and the more time it may cause the corresponding optimization pass to take for optimization.

In some embodiments, the time-costing weight of a task can be determined based on a real time-costing of a same task which was executed previously. Besides calculating the time-costing weight of a task as above, the weight can be obtained from a previous compiling. During compiling, when the execution of a task may be completed, the real time-costing weight of the task can be stored for a next compiling process. Then in the next compiling process, the time-costing weight of a task can be determined by referring to the relatively accurate time-costing weight of the same task from the previous compiling.

As will be explained in more detail below, step 230 may optionally include step 270 after step 230. Step 270 may be shown in FIG. 2, method 200, using dashed lines which may represent the optionality of updating the one or more task chains in response to newly generated tasks.

Additionally, as will be explained in more detail below, step 230 may optionally include step 280 after step 210. Step 280 may be show in FIG. 2, method 200, using dashed lined which may represent the optionality of updating the critical task chain based on the updated one or more task chains.

Referring back to FIG. 2, at step 240, the critical task chain can be scheduled to be executed with the highest priority and other task chains can be scheduled to be executed in parallel with the critical task chain. Scheduling the critical task chain to be executed with the highest priority can indicate to schedule the one or more tasks in the critical task chain to be executed as early as possible. Scheduling the other task chains to be executed in parallel with the critical task chain can indicate to schedule the one or more tasks in the other task chains to be executed at the same time with the one or more tasks in the critical task chain based on available compiling resources such as CPU and memory. That may be, the compiling resources can be assigned to ensure the one or more tasks in the critical task chain to be executed in time as soon as possible due to the fact that the critical task chain would cost the most time, and if there are any remaining available compiling resources, they can be assigned to the one or more tasks in the other task chains, which maximizes the use of compiling resources and reduces the whole compiling time.

The one or more tasks in the critical task chain may depend on one or more tasks in the other task chains. As shown in the example of FIG. 3, task 319 in the critical task chain has a dependency on task 312 in another task chain, and task 320 in the critical task chain has a dependency on task 317 in another task chain. The depended tasks 312 and 317 have to be executed in time to avoid blocking of the execution of the tasks in the critical task chain. Therefore, in some embodiments, the scheduling the other task chains to be executed in parallel with the critical task chain can include scheduling a first task (for example, task 312 or 317) in the other task chains that may depended by a second task (for example, task 319 or 320) in the critical task chain to be executed before execution of the second task.

One or more of the tasks generated at step 210 may be related to small values of time-costing weights. For example, tasks whose optimization passes are related to loop-invariant code motion or dead code elimination cost a relatively short time to be executed. These tasks can be merged into one task to reduce overhead. Therefore, as further shown in FIG. 2, method 200 can optionally include a further step 250 after step 210. At step 250, one or more tasks in the plurality of tasks with time-costing weights less than a threshold can be merged into one task. The threshold can be set by a user or set as a default value according to practice. For example, referring to the tasks shown in FIG. 3, tasks 315 and 316, with time-costing weights of 50 and 20 respectively, can be merged into one task to reduce overhead.

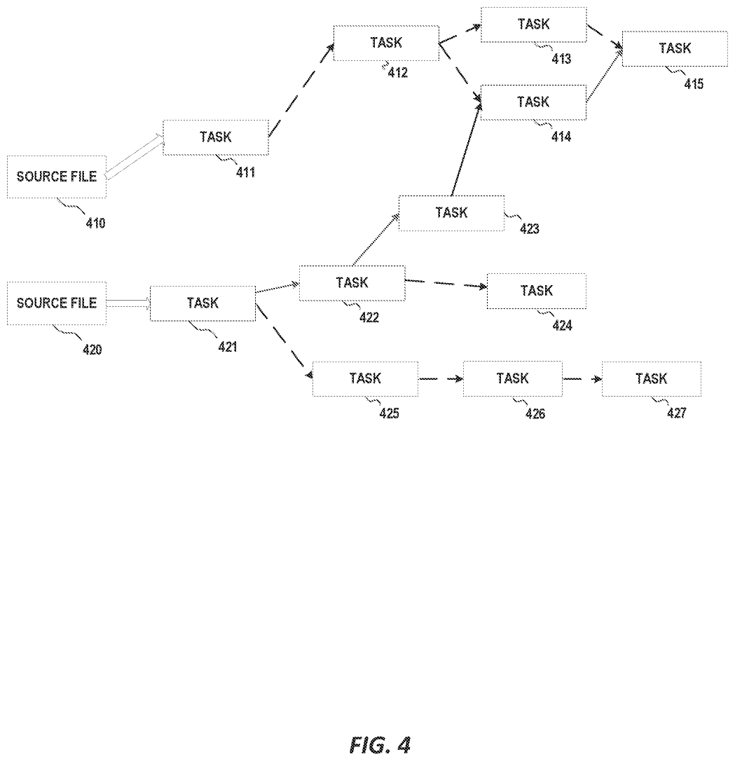

In some embodiments, the plurality of optimization passes can be related to not only a single source file, but also a plurality of source files, which makes the method 200 can not only be used in existing compilers such as LLVM (Low Level Virtual Machine), GCC (GNU Compiler Collection) and Microsoft C/C++ compiler to speed up compiling of a single source file, but also be incorporated into the existing building systems such as Make, CMake and Ninja to cooperate with existing building method to speed up compiling of multiple source files. With reference now to FIG. 4, it may depict an exemplary diagram of tasks related to two sources files and corresponding task chains. As shown in FIG. 4, tasks 411-415, and therefore their corresponding optimization passes, can be related to source file 410. In the meanwhile, tasks 421-427, and therefore their corresponding optimization passes, can be related to source file 420. A plurality of task chains are also shown in FIG. 4, among them, the critical task chain may be (421-422-423-414-415), the arrows in which are shown as solid lines, while the arrows in other task chains are shown as dash lines. It will be understood that although it may be shown in FIG. 4 that the tasks are related to two source files, they can be related to more than two source files, and there can be more tasks than those shown in FIG. 4.

In the case that the plurality of optimization passes are related to a plurality of source files, one or more tasks generated from different source files may be the same. In this circumstance, the execution can be done for just one task among the same (e.g., equivalent) and/or similar tasks to save compiling resources. Therefore, referring back to FIG. 2, in some embodiments, as further shown in FIG. 2, method 200 can optionally include a further step 260 after step 210. At step 260, two same (e.g., equivalent) and/or similar tasks generated based on two optimization passes which are related to two source files respectively can be reduced into one task. Referring back to FIG. 4, for example, task 412 and task 425 can be the same (e.g., equivalent) and/or similar, and they are generated based on two optimization passes which are related to two source files 410 and 420 respectively. Therefore, tasks 412 and 425 can be reduced into one task for execution to save compiling resources.

Multiple source files may be dynamically scheduled in the existing building systems to be compiled. At one given time, a first task chain that has the maximum time-costing weight can be identified to be the critical task chain. When a source file may be newly scheduled to be compiled in the building systems, there will be a change in the generated tasks (i.e., new tasks will be generated) and correspondingly a change in the task chains. In this case, a second task chain in the changed task chains can be identified to be the critical task chain if it has the maximum time-costing weight. That is, the critical task chain can be changed dynamically. Therefore, in some embodiments, as shown in FIG. 2, after the steps 210-230, method 200 can optionally include further steps 270-280. At step 270, the one or more task chains can be updated in response to newly generated tasks. At step 280, the critical task chain can be updated based on the updated one or more task chains.

In view of the above, embodiments of the present disclosure can make compiling be performed in units of tasks and make the tasks can be executed in parallel, maximizing use of compiling resources and reduce compiling time. embodiments of the present disclosure can not only speed up compiling of a single source file, but also be incorporated into the existing building systems to speed up compiling of multiple source files.

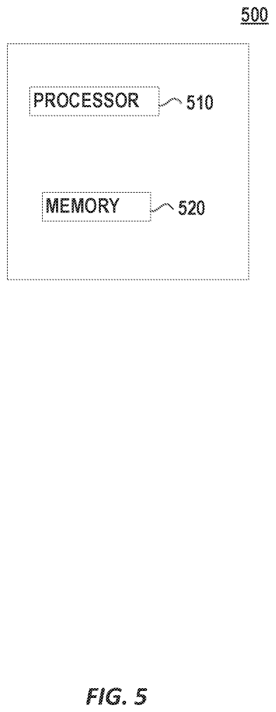

Referring now to FIG. 5, may depict a system 500 for task management in a compiling process with a plurality of optimization passes according to an embodiment of the present disclosure. The system 500 can comprise one or more processors 510 and a memory 520 coupled to at least one of the processors 510. A set of computer program instructions are stored in the memory 520. When executed by at least one of the processors 510, the set of computer program instructions perform following series of actions for task management in a compiling process with a plurality of optimization passes. A plurality of tasks can be generated. Each optimization pass in the plurality of optimization passes can operate on an operation unit smaller than a source file, and each task in the plurality of tasks can be represented by an optimization pass in the plurality of optimization passes and a corresponding operation unit of the optimization pass. A plurality of task chains can be determined based on dependencies among the plurality of tasks. Each of the plurality of task chains can comprise one or more tasks of the plurality of tasks. A critical task chain with a maximum time-costing weight can be identified from the plurality of task chains based on a time-costing weight of each task chain in the plurality of task chains. The critical task chain can be scheduled to be executed with the highest priority and other task chains can be scheduled to be executed in parallel with the critical task chain.

In some embodiments, the scheduling the other task chains to be executed in parallel with the critical task chain can comprise scheduling a first task in the other task chains that may depended by a second task in the critical task chain to be executed before execution of the second task.

In some embodiments, the dependencies among the plurality of tasks can be based on dependencies among corresponding optimization passes and/or dependencies among corresponding operation units.

In some embodiments, the time-costing weight of a task chain can be a sum of time-costing weights of the one or more tasks in the task chain.

In some embodiments, the time-costing weight of a task can be calculated based on a time complexity of the corresponding optimization pass and a size of the corresponding operation unit.

In some embodiments, the time-costing weight of a task can be determined based on a real time-costing of a same (e.g., equivalent) and/or similar task which was executed previously.

In some embodiments, after the generating the plurality of tasks, the set of computer program instructions can further perform actions of merging one or more tasks in the plurality of tasks with time-costing weights less than a threshold into one task

In some embodiments, the plurality of optimization passes can be related to a plurality of source files.

In some embodiments, after the generating the plurality of tasks, the set of computer program instructions can further perform actions of reducing two same (e.g., equivalent) and/or similar tasks generated based on two optimization passes which are related to two source files respectively into one task.

In some embodiments, the operation unit can be a function, a loop or a basic block.

The descriptions above related to the process of method 200 can be applied to system 500, details are omitted herein for conciseness.

It may be appreciated that FIGS. 2-5 provide only an illustration of one embodiment and do not imply any limitations with regard to how different embodiments may be implemented. Many modifications to the depicted embodiment(s) may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what may be shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of one or more transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for task management, the method comprising:
generating a plurality of tasks, wherein each optimization pass in a plurality of optimization passes operates on an operation unit smaller than a source file, wherein each task in the plurality of tasks is represented by an optimization pass in the plurality of optimization passes and a corresponding operation unit of the optimization pass;
determining a plurality of task chains based on dependencies among the plurality of tasks, wherein each of the plurality of task chains comprises one or more tasks of the plurality of tasks;
identifying a critical task chain with a maximum time-cost weight from the plurality of task chains based on a time-costing weight of each task chain in the plurality of task chains; and
scheduling the critical task chain to be executed with a highest priority and other task chains to be executed in parallel with the critical task chain.

2. The method of claim 1, wherein the scheduling of the other task chains to be executed in parallel with the critical task chain further comprises:
scheduling a first task in the other task chains that is depended by a second task in the critical task chain to be executed before execution of the second task.

3. The method of claim 1, wherein the dependencies among the plurality of tasks are based on dependencies among corresponding optimization passes and/or dependencies among corresponding operation units.

4. The method of claim 1, wherein the time-costing weight of a task chain is a sum of time-costing weights of the one or more tasks in the task chain.

5. The method of claim 4, wherein the time-costing weight of a task is calculated based on a time complexity of the corresponding optimization pass and a size of the corresponding operation unit.

6. The method of claim 4, wherein the time-costing weight of a task is determined based on a real time-costing of a same task which was executed previously.

7. The method of claim 1, wherein generating the plurality of tasks further comprises:
merging one or more tasks of the plurality of tasks with time-costing weights less than a threshold into one task.

8. The method of claim 1, wherein the plurality of optimization passes are related to a plurality of source files.

9. The method of claim 8, wherein generating the plurality of tasks further comprises:
reducing two same tasks into one task, wherein the two same tasks are generated based on two optimization passes which are related to two source files respectively.

10. The method of claim 1, wherein the operation unit is a function, a loop, or a basic block.

11. A computer system for task management, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
generating a plurality of tasks, wherein each optimization pass in a plurality of optimization passes operates on an operation unit smaller than a source file, wherein each task in the plurality of tasks is represented by an optimization pass in the plurality of optimization passes and a corresponding operation unit of the optimization pass;
determining a plurality of task chains based on dependencies among the plurality of tasks, wherein each of the plurality of task chains comprises one or more tasks of the plurality of tasks;
identifying a critical task chain with a maximum time-cost weight from the plurality of task chains based on a time-costing weight of each task chain in the plurality of task chains; and
scheduling the critical task chain to be executed with a highest priority and other task chains to be executed in parallel with the critical task chain.

12. The computer system of claim 11, wherein the scheduling of the other task chains to be executed in parallel with the critical task chain further comprises:
program instructions, stored on at least one of the one or more computer-readable storage media for execution by at least one of the one or more processors via at least one of the one or more memories, to schedule a first task in the other task chains that is depended by a second task in the critical task chain to be executed before execution of the second task.

13. The computer system of claim 11, wherein the dependencies among the plurality of tasks are based on dependencies among corresponding optimization passes and/or dependencies among corresponding operation units.

14. The computer system of claim 11, wherein the time-costing weight of a task chain is a sum of time-costing weights of the one or more tasks in the task chain.

15. The computer system of claim 14, wherein the time-costing weight of a task is calculated based on a time complexity of the corresponding optimization pass and a size of the corresponding operation unit.

16. The computer system of claim 14, wherein the time-costing weight of a task is determined based on a real time-costing of a same task which was executed previously.

17. The computer system of claim 11, wherein generating the plurality of tasks further comprises:
program instructions, stored on at least one of the one or more computer-readable storage media for execution by at least one of the one or more processors via at least one of the one or more memories, to merge one or more tasks of the plurality of tasks with time-costing weights less than a threshold into one task.

18. The computer system of claim 11, wherein the plurality of optimization passes are related to a plurality of source files.

19. The computer system of claim 11, wherein generating the plurality of tasks further comprises:
program instructions, stored on at least one of the one or more computer-readable storage media for execution by at least one of the one or more processors via at least one of the one or more memories, to reduce two same tasks into one task, wherein the two same tasks are generated based on two optimization passes which are related to two source files respectively.

20. A computer program product for task management, comprising:
one or more computer readable storage media, and program instructions collectively stored on the one or more computer readable storage media, the program instructions comprising:
generating a plurality of tasks, wherein each optimization pass in a plurality of optimization passes operates on an operation unit smaller than a source file, wherein each task in the plurality of tasks is represented by an optimization pass in the plurality of optimization passes and a corresponding operation unit of the optimization pass;
determining a plurality of task chains based on dependencies among the plurality of tasks, wherein each of the plurality of task chains comprises one or more tasks of the plurality of tasks;
identifying a critical task chain with a maximum time-cost weight from the plurality of task chains based on a time-costing weight of each task chain in the plurality of task chains; and
scheduling the critical task chain to be executed with a highest priority and other task chains to be executed in parallel with the critical task chain.
